(19) United States
(12) Patent Application Publication
(10) Pub. No.: US 2026/0076348 A1
(43) Pub. Date: Mar. 19, 2026

(54) ROPELESS FISHING GEAR RETRACTING-AND-RELEASING DEVICE

(71) Applicants: National Taiwan University, Taipei City (TW); National Taiwan Ocean University, Keelung City (TW)

(72) Inventors: SHENG-WEI HUANG, Keelung City (TW); EDWARD CHEN, Taipei City (TW); EN-YI ZHOU, Taipei City (TW); LING-JI MU, Taipei City (TW); YU-TING HUNG, Taipei City (TW); CHEN-FEN HUANG, Taipei City (TW); Jenhwa Guo, Taipei City (TW)

(73) Assignees: National Taiwan University, Taipei City (TW); National Taiwan Ocean University, Keelung City (TW)

(21) Appl. No.: 19/301,279

(22) Filed: Aug. 15, 2025

(30) Foreign Application Priority Data
Sep. 18, 2024 (TW) 113135240

(51) Int. Cl. A01K 69/06

(52) U.S. Cl. CPC A01K 69/06

(57) ABSTRACT

A ropeless fishing gear retracting-and-releasing device has a casing, a buoyancy changing device, a power-supplying device, and a controller. The casing has a top cover mounted on a top opening, a bottom cover, and a through hole through the bottom cover. The buoyancy changing device has an upper seat and a lower seat in the casing, multiple fixing rods, a driver, and a piston. Two ends of each of the rods are respectively mounted on the upper seat and the lower seat. The driver is mounted in the casing. An end of the piston is connected to the driver. An accommodation space is formed between another end of the piston and the bottom cover and fluidly communicates with the through hole. The power-supplying device is mounted in the casing and electrically connected to the driver. The controller is mounted on the casing and electrically connected to the power-supplying device.

### BACKGROUND OF THE INVENTION

### 1. Field of the Invention

The present invention relates to a buoyancy adjustment device for fishing, especially to a ropeless fishing gear retracting-and-releasing device.

### 2. Description of the Prior Arts

According to the latest estimate, the population of North Atlantic right whales has declined for seven consecutive years. The decline is mainly due to entanglement in fishing gear, which kills most right whales, and the long-term health impacts of non-lethal entanglements also lead to reduced calving rates. With reference to FIG. 12, the conventional fishing gear mainly comprises a main rope 90, two float balls 91, two buoys 92, two anchors 93, multiple branch ropes 94, and multiple traps 95. An end of the main rope 90 is connected to one float ball 91 and one buoy 92, and another end of the main rope 90 is connected to another float ball 91 and another buoy 92. The main rope 90 is connected to the anchors 93, and the branch ropes 94 connected to the main rope 90 are configured to connect the traps 95. Therefore, when the fishing gear is thrown into the sea, the anchor 93 can position the main rope 90 and traps 95 on the seabed, and the float balls 91 and the buoys 92 float on the sea surface. After a certain period of time, the fishing boat can retrieve and recover the fishing gear. However, during the certain time period, two parts of the main rope 90 between the anchor 93 and the float ball 91 are vertical in the sea, such that large fishes are easily entangled by the main rope 90 when swimming therethrough. Therefore, for environmental protection, countries also vigorously promote ropeless fishing gear to reduce the impact on marine ecology.

The structure of most ropeless fishing gear today is mainly to install a communication controller on the trap and connect a float ball with a connecting line through a thermal fuse device. The float ball and the trap are connected by a rope, and the weight of the trap drags the buoy to the seabed. When receiving the signal, the communication controller drives the thermal fuse device to perform heating. After the thermal fuse device melts the connecting line between the thermal fuse device and the float ball, the float ball drives the rope to float to the sea surface by the buoyancy of the float ball. Fishermen use salvage float balls to reel in the rope and then pull up the traps on the seabed for recovery. This type of ropeless fishing gear structure operates by simply carrying and releasing a buoy.

However, the aforementioned technology of using a thermal fuse device to release the float ball requires a certain amount of electricity to achieve a complete fusion. However, as there are many variables in the sea, power shortages often occur. When the power supply is insufficient, the thermal fuse device cannot be completely fused, such that the connecting line cannot be disconnected and the float cannot float up. Disadvantages include low recovery rate, incomplete mechanical action, and fish loss and inability to recover on the seabed, resulting in great property losses. In addition, the thermal fuse device is complex, expensive, and non-reusable, therefore posing a great burden for fishermen. Therefore, the overall structure of the conventional ropeless fishing gear retracting-and-releasing device has the above-mentioned problems and shortcomings, which need to be improved.

To overcome the shortcomings, the present invention provides a ropeless fishing gear retracting-and-releasing device to mitigate or obviate the aforementioned problems.

### SUMMARY OF THE INVENTION

The main objective of the present invention is to provide a ropeless fishing gear retracting-and-releasing device. The ropeless fishing gear retracting-and-releasing device can adjust the buoyancy to be appropriate through a buoyancy changing device, such that the ropeless fishing gear can sink into the seabed with the traps and thereby protecting the marine ecology.

The ropeless fishing gear retracting-and-releasing device includes a casing, a buoyancy changing device, a power-supplying device, and a controller. The casing surrounds and forms an inner space, a top opening, and at least one through hole. The top opening and the at least one through hole fluidly communicate with the inner space. The casing comprises a top cover and a bottom cover, and the top cover and the bottom cover are opposite to each other. The top cover is mounted at and covers the top opening, and the at least one through hole is formed through the bottom cover.

The buoyancy changing device includes an upper seat, a lower seat, multiple fixing rods, a driver, and at least one piston. The upper seat and the lower seat are opposite to each other and are securely mounted in the casing. An end of each one of the fixing rods is securely mounted on the upper seat, and another end of each one of the fixing rods is securely mounted on the lower seat. The driver is mounted in the casing. An end of the at least one piston is connected to the driver. An accommodation space is formed between another end of the at least one piston and the bottom cover, and the accommodation space fluidly communicates with the at least one through hole.

The power-supplying device is mounted in the casing and is electrically connected to the driver. The controller is mounted in the casing and electrically connected to the power-supplying device and the driver.

The advantage is that the present invention can replace the conventional float ball and be thrown into the sea together with the trap, and the buoyancy of the present invention can be reduced through the driver and sink to the seabed with the trap. During the recovery, the buoyancy of the present invention is increased by the driver and the trap floats to the sea surface for fishermen to retrieve, hereby achieving ropeless fishing, such that when using the trap to catch crabs, lobsters and other creatures, there will be no rope suspending between the sea surface and the seabed, thereby avoiding the impact on the ecology. In addition, the structure of the present invention has a high actuation yield and can be reused, which can increase the fishing rate and reduce costs compared to the existing technology.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a ropeless fishing gear retracting-and-releasing device in the first embodiment in accordance with the present invention;

FIG. 2 is an exploded view of the ropeless fishing gear retracting-and-releasing device in the first embodiment in FIG. 1;

FIG. 3 is another exploded view of the ropeless fishing gear retracting-and-releasing device in the first embodiment in FIG. 1;

FIG. 4 is an exploded view of the buoyancy changing device of the ropeless fishing gear retracting-and-releasing device in the first embodiment in FIG. 1;

FIG. 5 is another exploded view of the buoyancy changing device of the ropeless fishing gear retracting-and-releasing device in the first embodiment in FIG. 1;

FIG. 6 is a sectional view of the ropeless fishing gear retracting-and-releasing device in the first embodiment in FIG. 1;

FIG. 7 is another sectional view of the ropeless fishing gear retracting-and-releasing device in the first embodiment in FIG. 1;

FIG. 8 is an enlarged view of the ropeless fishing gear retracting-and-releasing device in the first embodiment in FIG. 1;

FIG. 9 is a perspective view of a ropeless fishing gear retracting-and-releasing device in the second embodiment in accordance with the present invention;

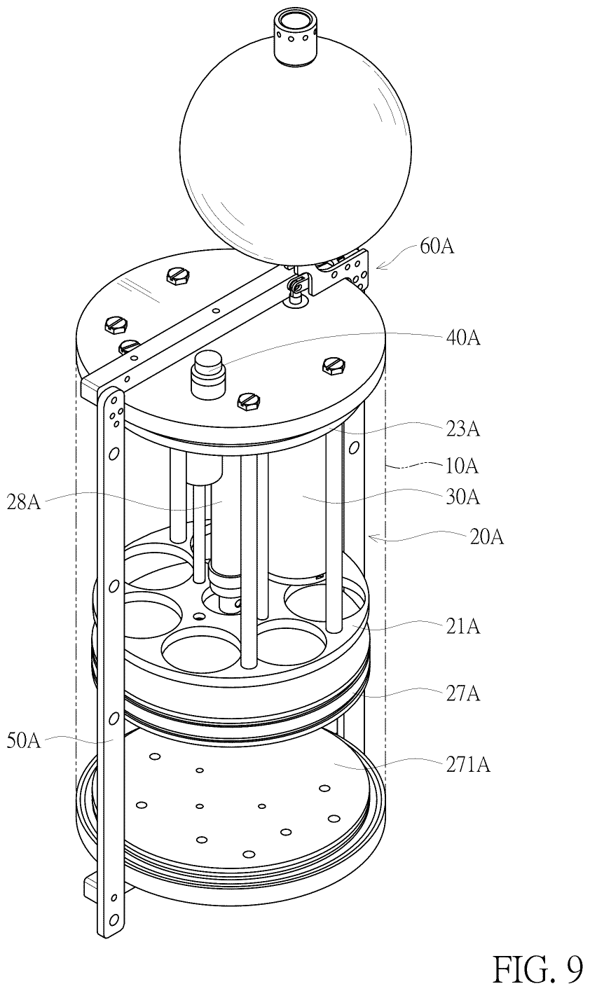

FIG. 10 is an exploded view of the ropeless fishing gear retracting-and-releasing device in the second embodiment in FIG. 10;

FIG. 11 is another exploded view of the ropeless fishing gear retracting-and-releasing device in the second embodiment in FIG. 10; and

FIG. 12 shows a fishing gear in accordance with the prior art.

### DETAILED DESCRIPTION OF THE PREFERRED EMBODIMENTS

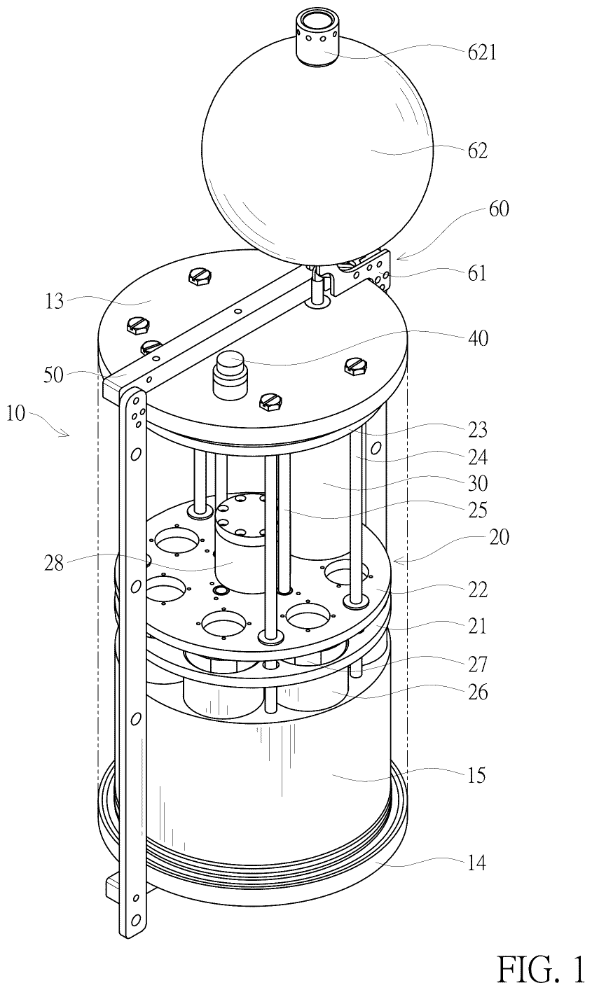

With reference to FIG. 1, a ropeless fishing gear retracting-and-releasing device of the first embodiment in accordance with the present invention includes a casing 10, a buoyancy changing device 20, a power-supplying device 30, a controller 40, an enforcement support frame 50, and a backup device 60.

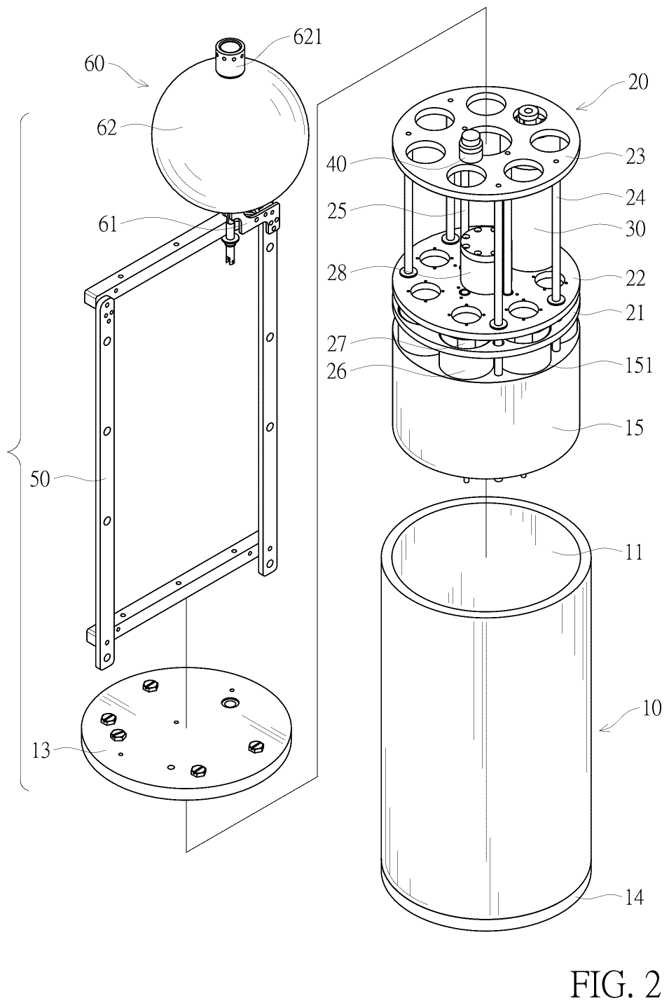

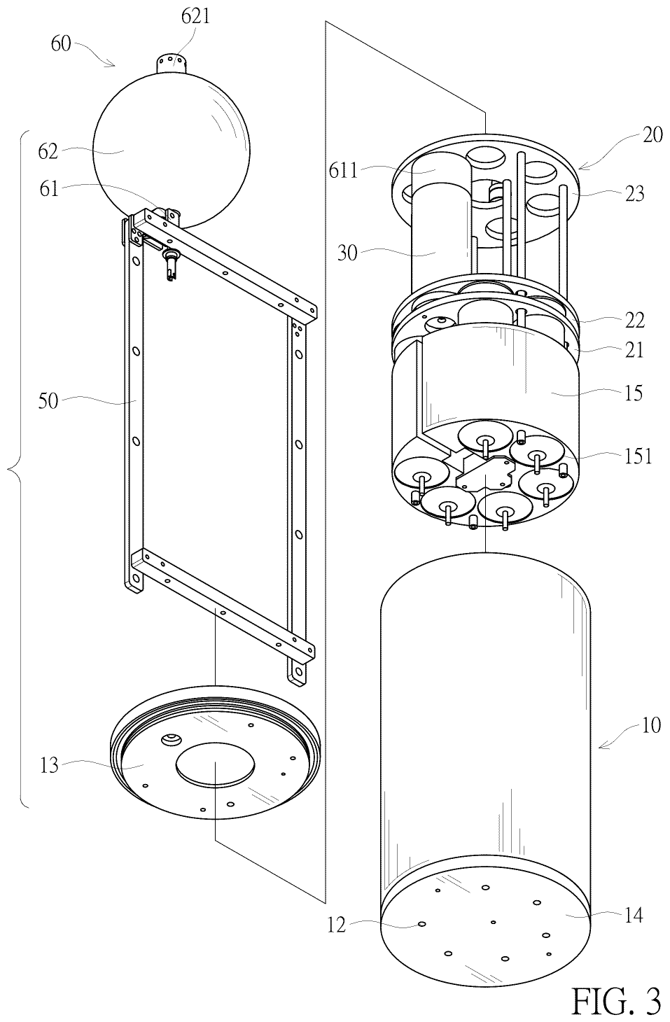

With reference to FIG. 2 and FIG. 3, the casing 10 surrounds and forms an inner space, a top opening 11, and at least one through hole 12. The top opening 11 and the at least one through hole 12 fluidly communicate with the inner space. In this embodiment, the casing 10 is a hollow cylinder, and the top opening 11 is located on an upper part of the hollow cylinder. The casing 10 comprises a top cover 13 and a bottom cover 14. The top cover 13 is mounted at and covers the top opening 11, and the bottom cover 14 is mounted at a bottom of the casing 10. The at least one through hole 12 includes multiple said through holes 12. The through holes 12 are formed around and through the bottom cover 14. A pressure-resistant unit 15 is mounted in the casing 10, and the pressure-resistant unit 15 can be a high-pressure foam material, but it is not limited thereto. The pressure-resistant unit 15 corresponds in shape to the inner space. Multiple abutting holes 151 are formed through the pressure-resistant unit 15. The pressure-resistant unit 15 is attached to an inner wall of the casing 10 and the bottom cover 14, and the abutting holes 151 respectively fluidly communicate with the corresponding through hole 12, but it is not limited thereto. The configuration of the casing 10 can be changed according to user needs, and the pressure-resistant unit 15 may be omitted.

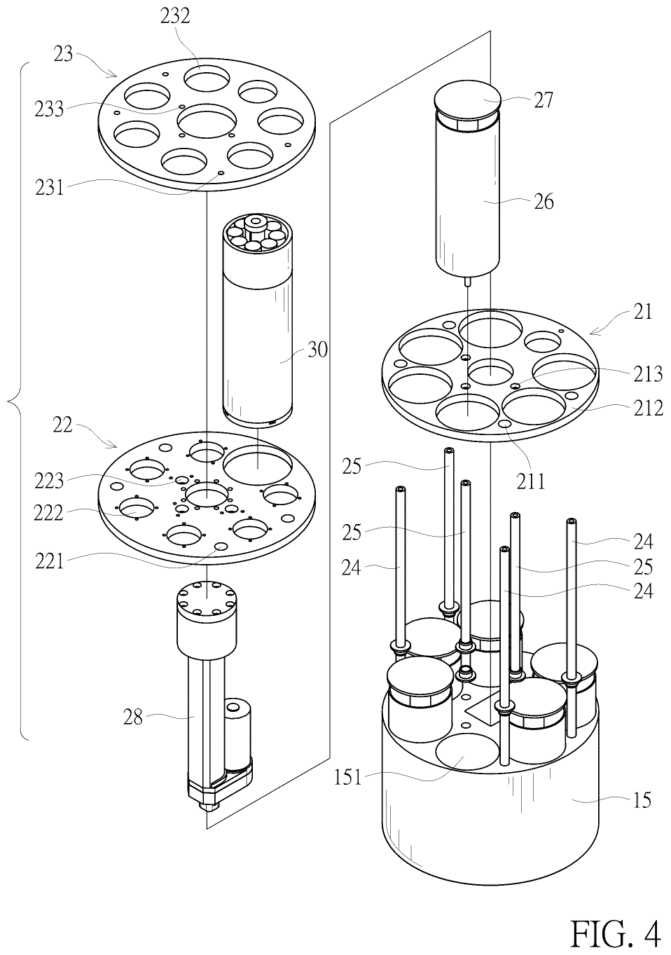

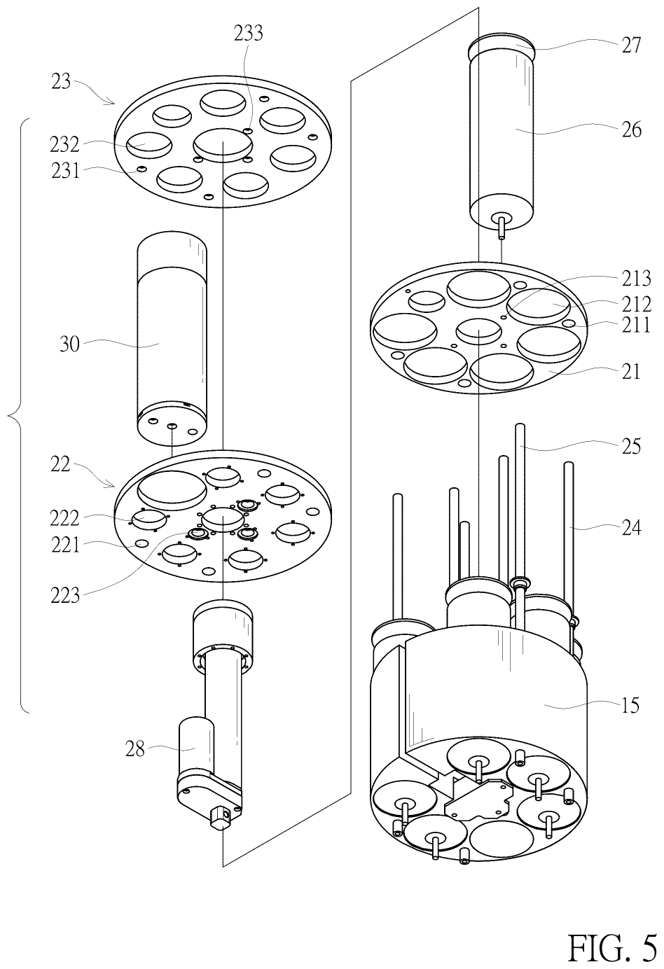

With reference to FIG. 2 to FIG. 5, the buoyancy changing device 20 includes a lower seat 21, a middle seat 22, an upper seat 23, multiple fixing rods 24, multiple guide tracks 25, multiple air cylinders 26, multiple pistons 27, and a driver 28. The lower seat 21 is a circular disc. Multiple lower fixing holes 211, multiple lower installing holes 212, and multiple lower track holes 213 are formed through the lower seat 21. The middle seat 22 is a circular disc. Multiple middle fixing holes 221, multiple middle installing holes 222, and multiple middle track holes 223 are formed through the middle seat 22. The upper seat 23 is a circular disc. Multiple upper fixing holes 231, multiple upper holes 232, and multiple upper track holes 233 are formed through the upper seat 23. Each one of the fixing rods 24 is mounted through the corresponding one of the middle fixing holes 221 of the middle seat 22, and two ends of each one of the fixing rods 24 are respectively mounted through and fixed at the corresponding one of the lower fixing holes 211 of the lower seat 21l and the corresponding one of the upper fixing holes 231 of the upper seat 23. The fixing rods 24 extend through and are mounted in the pressure-resistant unit 15. Each one of the guide tracks 25 is mounted through the corresponding one of the middle track holes 223 of the middle seat 22, and two ends of each one of the guide tracks 25 are respectively mounted through and fixed at the corresponding one of the lower track holes 213 of the lower seat 21 and the corresponding one of the upper track holes 233 of the upper seat 23, such that the middle seat 22 can move between the lower seat 21 and the upper seat 23 along the guide tracks 25. The upper holes 232 are used to reduce the weight of the upper seat 23, but it is not limited thereto, and the upper holes 232 may not be formed.

With reference to FIG. 3 to FIG. 6, each one of the air cylinders 26 is a hollow cylinder. An end of each one of the air cylinders is mounted through and fixed at the pressure-resistant unit 15 and fluidly communicates with the corresponding one of the through holes 12. Another end of each one of the air cylinders is mounted through and fixed at the corresponding one of the lower installing holes 212 of the lower seat 21. An end of each one of the pistons 27 is mounted through the corresponding one of the air cylinders 26. Another end of each one of the pistons 27 is securely mounted on the corresponding one of the middle installing holes 222 of the middle seat 22, such that the pistons 27 and the middle seat 22 can move together, and the pistons 27 can move up and down along the air cylinders 26. The piston 27 and the air cylinder 26 surround and form an accommodation space 271. The accommodation space 271 communicates with the through holes 12. By moving the piston 27 up and down in the air cylinder 26, the size of the accommodation space 271 can be changed, thereby changing the buoyancy of the present invention. The driver 28 is an electric cylinder, which is a standard and conventional component, and its detailed structure is omitted from the description. An end of the driver 28 is mounted through the pressure-resistant unit 15 and mounted on the bottom cover 14, and another end of the driver 28 is mounted on the middle seat 22. The driver 28 is used to drive the middle seat 22 to move.

The power-supplying device 30 is mounted in the casing 10 and is electrically connected to the driver 28. In this embodiment, the power-supplying device 30 is a cylindrical battery assembly. The power-supplying device 30 is mounted through a corresponding hole on the middle seat 22, and two ends of the power-supplying device 30 are respectively fixed at the lower seat 21 and the upper seat 23, but it is not limited thereto, as the configuration of the power-supplying device 30 can be changed according to user needs.

With reference to FIG. 1 to FIG. 3, the controller 40 is mounted on the casing 10 and is electrically connected to the power-supplying device 30 and the driver 28. In this embodiment, the controller 40 is an acoustic transmission device and comprises a control chip to activate the components. The control chip is conventional and therefore will not be described in detail. The controller 40 can be any other device, such as a radio transmission device or a timer, but it is not limited thereto.

The enforcement support frame 50 is mounted on the casing 10. Precisely, the enforcement support frame 50 is a stainless-steel frame, and the enforcement support frame 50 is securely mounted on the top cover 13 and the bottom cover 14 and surrounds the outer side of the casing 10 to strengthen the rigidity of the casing 10, but it is not limited thereto. The enforcement support frame 50 may be omitted.

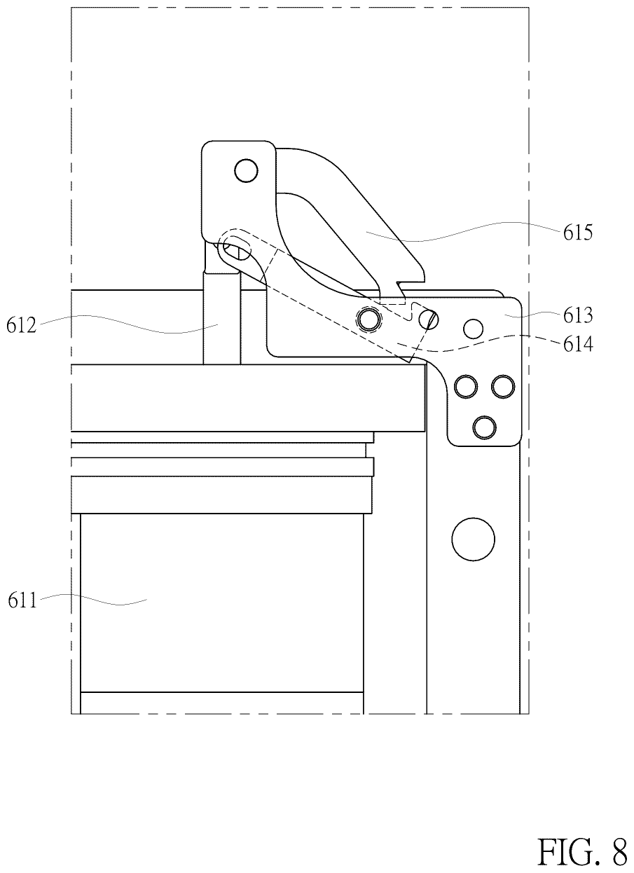

The backup device 60 includes a release mechanism 61 and a float ball 62. With reference to FIG. 8, the release mechanism 61 comprises a driving cylinder 611, a driving rod 612, a fixing assembly 613, a lower pivot hook 614, and an upper pivot hook 615. The driving cylinder 611 is mounted in the casing 10 and is electrically connected to the power-supplying device 30 and the controller 40. An end of the driving rod 612 is mounted on the driving cylinder 611 and is retractable relative to the driving cylinder 611. The fixing assembly 613 is mounted on the enforcement support frame 50. The lower pivot hook 614 is pivotably mounted on the fixing assembly 613. An end of the lower pivot hook 614 is pivotably connected to the driving rod 612. An end of the upper pivot hook 615 is pivotably connected to the fixing assembly 613. Another end of the lower pivot hook 614 and another end of the upper pivot hook 615 can be selectively hooked with or separated from each other via pivoting. The float ball 62 comprises a flash device 621 to emit light, but it is not limited thereto. The flash device 621 may not be provided. The float ball 62 is connected to the release mechanism 61 through a rope (not shown in figures). Precisely, the rope can be tied to the upper pivot hook 615, and the driving cylinder 611 of the release mechanism 61 is connected to the controller 40 and the power-supplying device 30. In this embodiment, the controller 40 can be used to control the driving rod 612 of the driving cylinder 611 to retract, such that the lower pivot hook 614 and the upper pivot hook 615 are hooked with each other to fix the float ball 62. When the driving rod 612 is extended, the lower pivot hook 614 and the upper pivot hook 615 are disconnected from each other, and then the buoyancy of the float ball 62 drives the upper pivot hook 615 to pivot upward, such that the rope is separated from the upper pivot hook 615 to release the float ball 62, but it is not limited thereto. The release mechanism 61 can be a hook or any other device with a release function, which is a standard and conventional component, so its detailed structure is not repeated here.

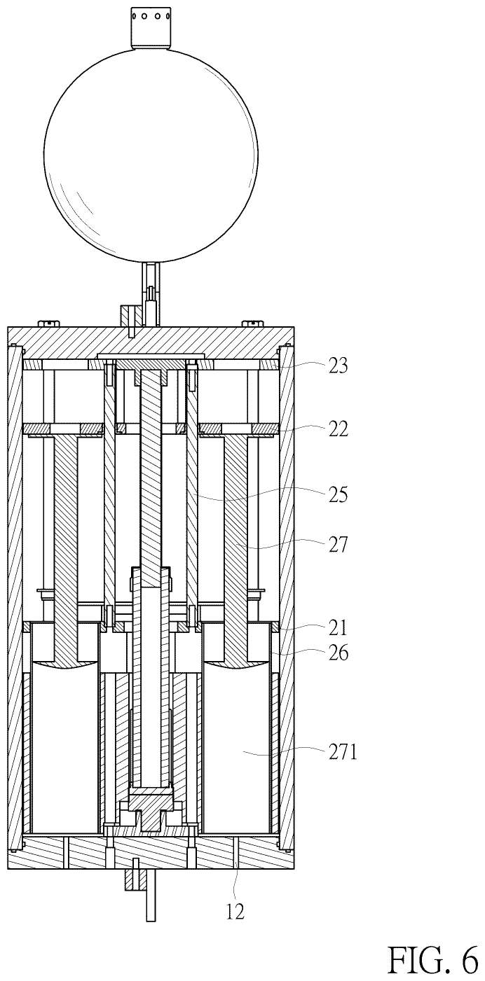

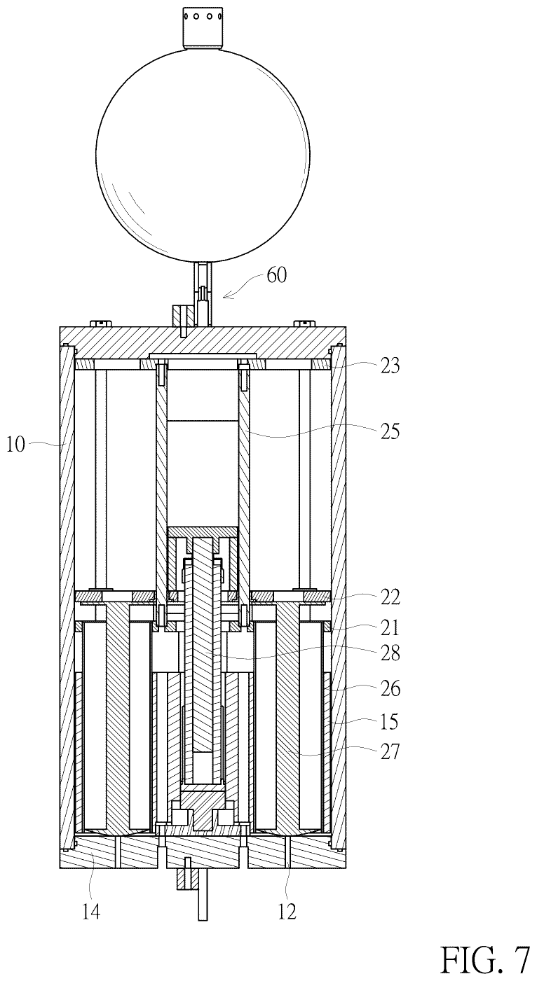

With reference to FIG. 6, when the present invention is in use, the trap is connected through a main rope (not shown in figures). Then the present invention and the trap are thrown into the sea, and the middle seat 22 drives the piston 27 to move toward the top cover 13 through the driver, such that the external seawater is sucked into the air cylinder 26 from the through hole 12 and enters the casing 10, thereby reducing the buoyancy generated by the present invention, and the weight of the trap and the present invention is greater than the reduced buoyancy, such that the trap and the present invention can sink to the seabed. With reference to FIG. 2 and FIG. 7, when the fishing trap is recovered, a signal is sent to the controller 40 to activate the driver 28. The driver 28 drives the middle seat 22 to move toward the bottom cover 14, and the piston 27 connected to the middle seat 22 discharges the seawater in the air cylinder 26 out of the casing 10, thereby increasing the air in the casing 10 and further increasing the buoyancy of the present invention. At this time, because the buoyancy is greater than the weight of the present invention, the present invention can float to the sea surface with the main rope, and the fisherman can retrieve the trap onto the boat by reeling in the main rope. The present invention is connected to a trap to replace the float ball in the prior art, achieving ropeless fishing, such that when using the trap to catch crabs, lobsters and other creatures, there will be no rope floating in the sea, thereby avoiding affecting the ecology. The structure of the present invention has a high yield in activation and can be reused, which can increase the catch rate and reduce costs compared to the prior art.

In the above process, with the backup device 60, even when the piston 27 of the present invention is stuck and fails, the controller 40 can be used to control and drive the release mechanism 61 to release the float ball 62. After the float ball 62 floats on the sea surface, the fishing trap can also be used to reduce property losses, conserve the marine ecology and reduce marine garbage.

In the above process, because the multiple air cylinders 26 and multiple pistons 27 are provided, when failure occurs, the failed components can each be replaced individually, thereby reducing costs and improving convenience. Moreover, even if one set of the air cylinders 26 or the pistons 27 fails during use, as long as the other sets of the air cylinders 26 and the pistons 27 can operate normally to discharge seawater, the device can still float without affecting the function of the present invention, thereby improving the yield rate.

In the above process, the pressure-resistant unit 15 is used to abut against the air cylinder 26, thereby improving pressure resistance of the air cylinder 26 and reducing deformation of the air cylinder 26.

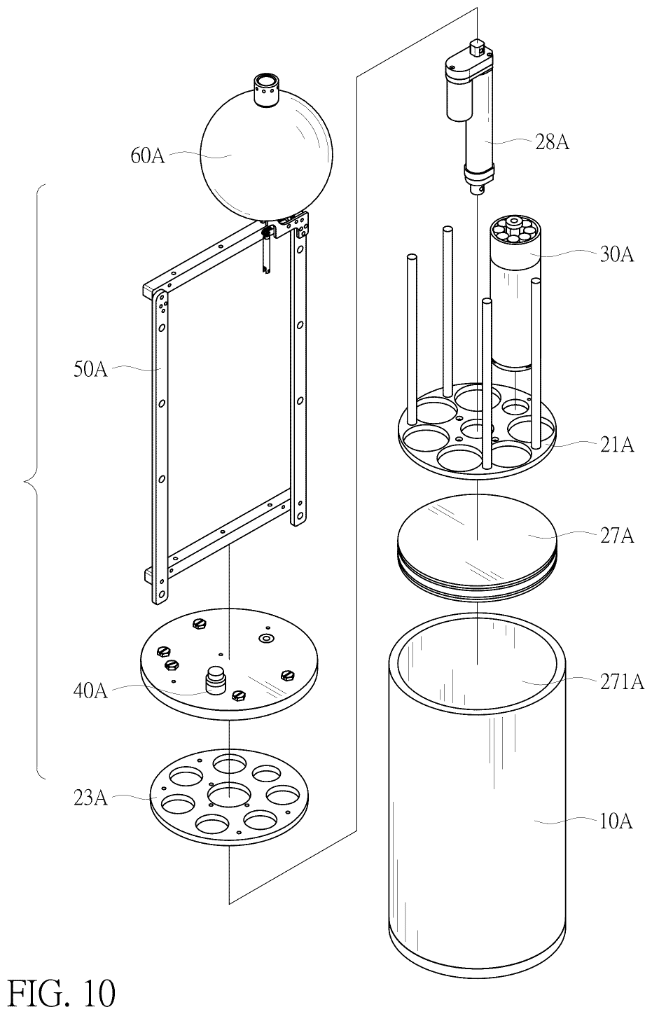

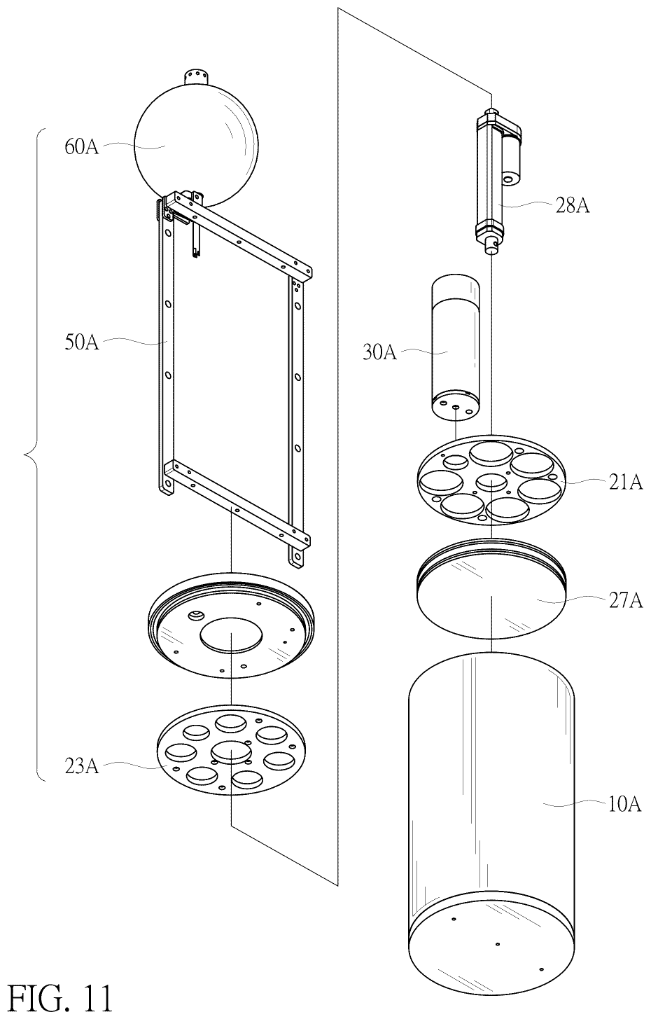

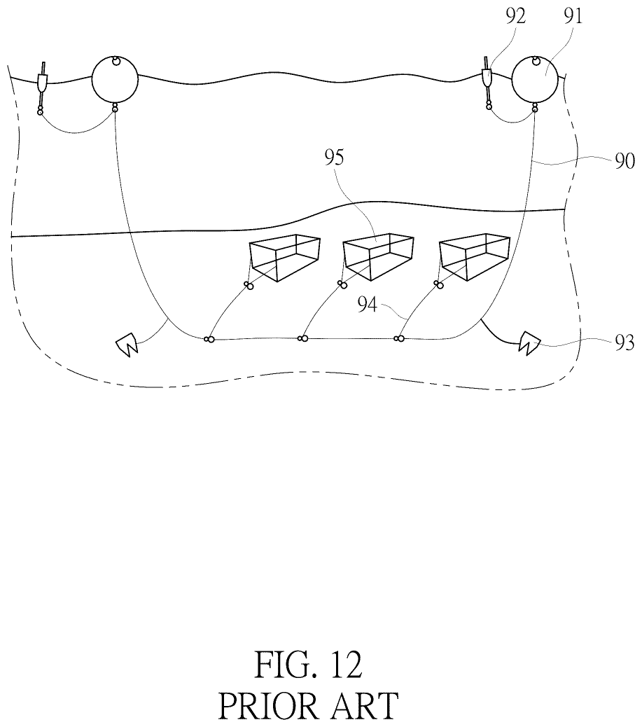

With reference to FIG. 10 to FIG. 12, in the second embodiment of the present invention, the casing 10A, the power-supplying device 30A, the controller 40A, the enforcement support frame 50A, and the backup device 60A are the same as those in the first embodiment. The main difference is that the buoyancy changing device 20A is changed from a multi-cylinder configuration to a single-cylinder configuration. Precisely, the casing 10A can be regarded as a part of the wall of an air cylinder. The middle seat 22 and the guide tracks 25 are not provided, and the driver 28A is securely mounted on the upper seat 23A and the lower seat 21A. The piston 27A is a circular disc and is connected to the driver 28A. The piston 27A is located below the lower seat 21A and an O-ring is mounted around on the piston 27A. The accommodation space 271A is formed between the piston 27A and the casing 10A. The driver 28A drives the piston 27A to move up and down in the casing 10A, to suck in or discharge seawater.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A ropeless fishing gear retracting-and-releasing device comprising:
a casing surrounding and forming an inner space, a top opening, and at least one through hole; the top opening and the at least one through hole fluidly communicating with the inner space; the casing comprising a top cover and a bottom cover, and the top cover and the bottom cover being opposite to each other; the top cover mounted at and covering the top opening, and the at least one through hole formed through the bottom cover;
a buoyancy changing device including an upper seat, a lower seat, multiple fixing rods, a driver, and at least one piston; the upper seat and the lower seat being opposite to each other and securely mounted in the casing; an end of each one of the fixing rods securely mounted on the upper seat, and another end of each one of the fixing rods securely mounted on the lower seat; the driver mounted in the casing; an end of the at least one piston connected to the driver; an accommodation space formed between another end of the at least one piston and the bottom cover, and the accommodation space fluidly communicating with the at least one through hole;
a power-supplying device mounted in the casing and electrically connected to the driver;
a controller mounted on the casing and electrically connected to the power-supplying device and the driver.

2. The ropeless fishing gear retracting-and-releasing device as claimed in claim 1, wherein the ropeless fishing gear retracting-and-releasing device comprises multiple air cylinders, a middle seat, and multiple guide tracks; each one of the air cylinders securely mounted on the lower seat and fluidly communicating with the at least one through hole; the middle seat mounted between the upper seat and the lower seat and connected to the driver; each one of the guide tracks mounted through the middle seat, and two ends of each one of the guide tracks securely mounted on the upper seat and the lower seat respectively; the at least one piston including multiple said pistons; said end of each one of the pistons connected to the middle seat, and said another end of each one of the pistons mounted through each one of the air cylinders.

3. The ropeless fishing gear retracting-and-releasing device as claimed in claim 1, wherein the ropeless fishing gear retracting-and-releasing device includes a backup device; the backup device including a release mechanism and a float ball; the release mechanism electrically connected to the controller and the power-supplying device; the float ball connected to the release mechanism through a rope; the release mechanism being capable of fixing or releasing the float ball.

4. The ropeless fishing gear retracting-and-releasing device as claimed in claim 2, wherein the ropeless fishing gear retracting-and-releasing device includes a backup device; the backup device including a release mechanism and a float ball; the release mechanism electrically connected to the controller and the power-supplying device; the float ball connected to the release mechanism through a rope; the release mechanism being capable of fixing or releasing the float ball.

5. The ropeless fishing gear retracting-and-releasing device as claimed in claim 3, wherein the float ball comprises a flash device.

6. The ropeless fishing gear retracting-and-releasing device as claimed in claim 4, wherein the float ball comprises a flash device.

7. The ropeless fishing gear retracting-and-releasing device as claimed in claim 1, wherein the ropeless fishing gear retracting-and-releasing device includes an enforcement support frame; the enforcement support frame surrounding and mounted on the casing and fixed on the top cover and the bottom cover.

8. The ropeless fishing gear retracting-and-releasing device as claimed in claim 6, wherein the ropeless fishing gear retracting-and-releasing device includes an enforcement support frame; the enforcement support frame surrounding and mounted on the casing and fixed on the top cover and the bottom cover.

9. The ropeless fishing gear retracting-and-releasing device as claimed in claim 1, wherein the controller is an acoustic transmission device, a radio transmission device, or a timer.

10. The ropeless fishing gear retracting-and-releasing device as claimed in claim 8, wherein the controller is an acoustic transmission device, a radio transmission device, or a timer.

11. The ropeless fishing gear retracting-and-releasing device as claimed in claim 2, wherein the ropeless fishing gear retracting-and-releasing device includes a pressure-resistant unit; the pressure-resistant unit corresponding in shape to the inner space; multiple abutting holes formed through the pressure-resistant unit; the pressure-resistant unit mounted in the casing and attached to an inner wall of the casing and the bottom cover, and each one of the air cylinders mounted through a respective one of the abutting holes.

12. The ropeless fishing gear retracting-and-releasing device as claimed in claim 10, wherein the ropeless fishing gear retracting-and-releasing device includes a pressure-resistant unit; the pressure-resistant unit corresponding in shape to the inner space; multiple abutting holes formed through the pressure-resistant unit; the pressure-resistant unit mounted in the casing and attached to an inner wall of the casing and the bottom cover, and each one of the air cylinders mounted through a respective one of the abutting holes.

13. The ropeless fishing gear retracting-and-releasing device as claimed in claim 1, wherein multiple upper holes are formed through the upper seat.

14. The ropeless fishing gear retracting-and-releasing device as claimed in claim 12, wherein multiple upper holes are formed through the upper seat.

15. The ropeless fishing gear retracting-and-releasing device as claimed in claim 3, wherein the release mechanism comprises a driving cylinder, a driving rod, a fixing assembly, a lower pivot hook, and an upper pivot hook; the driving cylinder mounted in the casing and electrically connected to the power-supplying device and the controller; an end of the driving rod movably mounted on the driving cylinder; the fixing assembly mounted outside the casing; the lower pivot hook pivotably mounted on the fixing assembly; an end of the lower pivot hook pivotably connected to another end of the driving rod, an end of the upper pivot hook pivotably connected to the fixing assembly, and another end of the lower pivot hook and another end of the upper pivot hook selectively hooked with or separated from each other.

16. The ropeless fishing gear retracting-and-releasing device as claimed in claim 14, wherein the release mechanism comprises a driving cylinder, a driving rod, a fixing assembly, a lower pivot hook, and an upper pivot hook; the driving cylinder mounted in the casing and electrically connected to the power-supplying device and the controller; an end of the driving rod movably mounted on the driving cylinder; the fixing assembly mounted outside the casing; the lower pivot hook pivotably mounted on the fixing assembly; an end of the lower pivot hook pivotably connected to another end of the driving rod, an end of the upper pivot hook pivotably connected to the fixing assembly, and another end of the lower pivot hook and another end of the upper pivot hook selectively hooked with or separated from each other.
